(19) United States
(12) Patent Application Publication
(10) Pub. No.: US 2004/0168022 A1
(43) Pub. Date: Aug. 26, 2004

(54) Pipeline scalable architecture for high density and high speed content addressable memory (CAM)

(76) Inventor: Xiaohua Huang, Saratoga, CA (US)

Correspondence Address: Xiaohua Huang, 12897 Regan Lane, Saratoga, CA, 95070, US

(21) Appl. No.: 10/667,803

(22) Filed: Sep. 22, 2003

Related U.S. Application Data
(60) Provisional application No. 60/414,030, filed on Sep. 26, 2002.

(51) Int. Cl. G06F 12/00

(52) U.S. Cl. 711/108

(57) ABSTRACT

The Inventions divide the entire CAM block into many identical small sub-block and then symmetrically place them. Divide them into four quadruple, then in each quadruple place them in equal row and column. the address, data bus are routed symmetrically into the center first and then to each quadruple, then to each column in each quadruple and then into each sub-block. Address decoding, Content matching in each sub-block, priority encoding, hit result reading out in different cycle. In this way, each cycle time can be short, and the throughput of CAM matching can be increased. In this design the power can be reduced. Each sub-blocks are identical. The logical interface among sub-block in each column are identical. The design is scalable.

This application claims the benefit of provisional U.S. patent Application Serial No. 60/414,030 entitled “Pipeline Scalable Architecture for High Density and High Speed Content Addressable Memory (CAM) Design”, filed Sep. 26, 2002 which is incorporated herein by reference in its entirety for all purposes.

### FIELD OF THE INVENTION

The present invention is related to content addressable memory. In particular, The invention is related to the Pipe line scalable architecture with hierarchy address decoding and priority encoding.

### BACKGROUND OF THE INVENTION

### Brief Description of CAM

Basically, CAM is a memory like SRAM or DRAM, which stores M word and each word is N bit wide, so the total capacity of the memory will be M×N bits. Besides that CAM can perform simultaneous comparison for a N bit input with all the M word stored in the memory. If one of the M word is equal to the input content on every bit, we say they are matching, and the device will indicate a hit and also give the address in which the matched word is stored.

If none of the M word is equal to the input content, the device will indicate a miss. If more than one word are equal to the input content, usually the device will pick up the address with high priority and indicate a multi-hit.

Up to now, we got a picture that a CAM needs three functions,

1) memory function, which is just like a regular SRAM, with read and write ability,

2) comparison or search which can perform simultaneous comparison between an input content and all the M word stored in the memory.

3) priority encoding, which picks up the address that has highest priority if more than one match or hit happens.

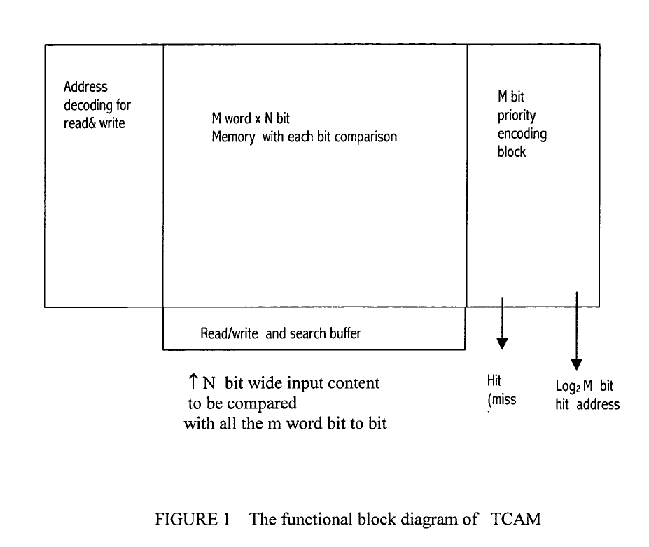

FIG. 1 is the functional block diagram of CAM.

For two Meg bit CAM, if each word is 128 bit wide, there will be 16 K word. If we put every thing in one block as shown in FIG. 1. The device will run very slow. The reason for this is as follows:

a) For read and write. The address decoding needs one cycle and cannot be further pipelined. Because 16 K word addresses the address line has huge loading, also the address line itself is also very long. Both wire resistance and loading capacitance, so the RC delay is huge.

b) Both read and write bit line will be very long and 16 K device loading, and for the same RC delay reason, will be very slow.

c) The match data bit line will be long and also has 16 K device loading and RC delay will be large.

d) The priority encoding will be slow. With 16 K input, that is a huge series logic process. It will take a long time. Assume we use hierarchy multilevel encoding, we still need to finish all the encoding within one cycle.

The cycle time will be long.

For the reasons discussed above, we came out with the invention, which will be described in this filing in the following.

### SUMMARY OF THE INVENTION

The Inventions divide the entire CAM block into many identical small sub-block and then symmetrically place them. Divide the address, data bus routing, address decoding, content matching, priority encoding, hit result reading out in different cycle. In this kind pipe line way, each cycle time can be short, and the throughput of CAM matching can be increased. In this design the power can be reduced. The sub block searching can be achieved. The foregoing, together with other aspects of this invention, will become more apparent when referring to the following specification, claims, and accompanying drawings.

### BRIEF DESCRIPTION OF THE DRAWINGS

1. FIG. 1 The conventional CAM functional diagram

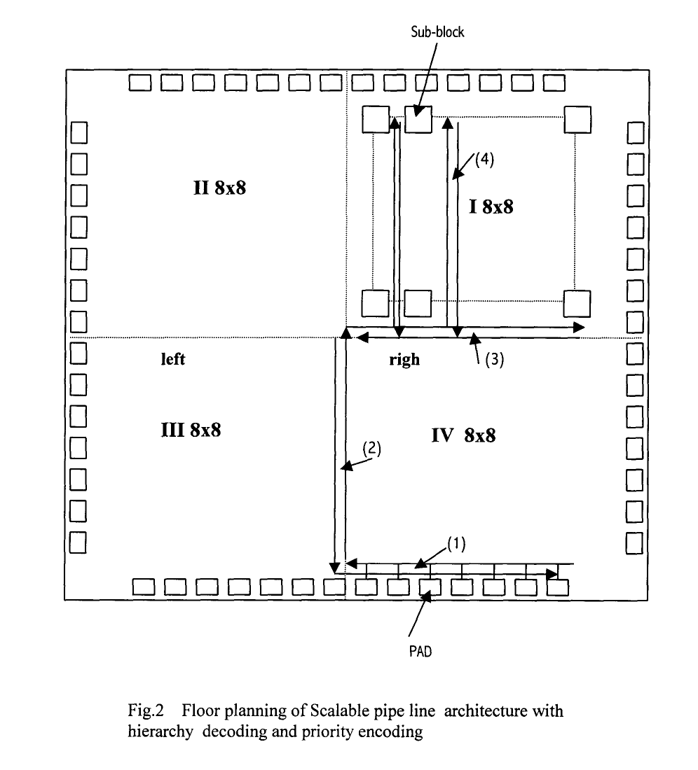

2. FIG. 2 The Hierarchy scalable pipe line CAM architecture

### DESCRIPTION OF THE SPECIFIC EMBODIMENTS

### The Floor Plan

Here we take 2 Meg bit SRAM based CAM as example (for ternary, the SRAM is four Meg bit, but the principle is the same). We assume the width of each word is 128=2⁷ bit, so total 2×2²⁰/2⁷=16×2¹⁰=2¹⁴ word. We need 14 bit address to identify each word location. We divide the entire memory into 256=2⁸ small sub blocks, so each sub block has 2¹⁴/2⁸=2⁶=64 word. The floor plan is shown in FIG. 2. We further divide the 256 sub block into four quadruple. Each quadruple has 8×8=64 sub-block as shown in FIG. 2. The four quadruples are arranged symmetrically. Each sub-block has only 64 word, it is a small SRAM or small CAM, and it can run fast. For 4 Meg bit or 8 Meg bit, the small sub-blocks become 128 word, or 256 word. Still, can run quite fast.

### The Bus Routing

As shown in FIG. 2, all the addresses and data and control signals are input from the PAD which are located near the boundary of the chip. First step in routing the signal from the pad at each side (four sides) to the mid point of that side shown as route, (1) in FIG. 2, and then buffered. Second step routing each group signal of the four sides to the center of the chip shown in FIG. 2 is (2) only one route is drawn, the third route is from the center to the mid point of each side of the chip.

Marked as (3) only one was shown in FIG. 2.

The fourth step, the signal in route (3) are decoded (on SRAM read and write case), and then sent to one of the eight columns in one of the quadruples, as route (4).

Signal route (4) further decoded into one of the eight sub-blocks in the column. The signal of route (4) could be buffered at the starting point of route (4).

For the CAM searching function, no decoding are required and the route (3) signal will be buffered into all the eight columns in each quadruple and then written into each sub-block in each column.

### Multi-Level Decoding

For SRAM operation, read and write, first of all we need to find the address. in the 2 Meg bit example as we discussed above, total 14 bits address, each sub-block has 6 bit address, and 8 bit are for 256 blocks. We name them as A7, A6, A5, A4, A3, A2, A1, A0. For a given particular address, it is a unique combination of all 14 bit address and corresponding a particular word, here we are concentrated in finding the sub-block in which that particular word is located. First level decoding is in the center of the chip between route (2) and route (3) then decide the address is in the left or right side. It is decided by Bit A7, we arranged it as if A7=1, the address is on the right side. And if the A7=0, the address is on the left side. In route (3), if A6=1 the address is in the upper side(quadruple I or II), if A6=0, the address in the lower side (quadruple III, or IV). {A5, A4, A3} together decide which one column out of 8 column. Based on common 3 to 8 decoding. In route (4), {A2, A1, A0} together decide which block out of 8 blocks are in that column.

After decoding, in each sub-block, it is just like the small block SRAM, CAM design perform read and write, and search for comparisons.

### Multi-Level Muxing

After the block decoding, the data can be written into that block. For read case, the data read out will take the read data bus in route (4) while the other block without reading will not take the bus. Then this column in route (4) will take the read data bus in route (3). Then in route (2) and (1), route (1) is single bus no further muxing. The route (3) and route (4) read data bus will achieve the function described above easily through self-reseting dynamic circuit design.

### Multi-Level Priority Encoding

For CAM searching operation, the input content will be written into each block and compared with each word in every block. So the input data bus through route (1), (2), (3), (4), do not perform any decoding. After compared inside each block, the matching result should be read out, also needs to perform priority encoding among 256 sub-blocks if multi-hit in one sub-block or hit happens in different blocks. First step priority encoding (8 to 1) in route (4). The block has highest priority hit will catch the hit result bus, and then the hit address will take the bus. Second step priority among 8 column (8 to 1) in route (3), the highest priority hit column will take the bus and then the hit address in that column will take the hit result bus in route (3).

Step 3, from route (3), to route (2), it is 2 to 1 priority encoding, then in route (2) and route (1) no further encoding.

### Pipeline Design

Based on the description from section [6] to section [10], we can implement pipeline design in the following way:

make the path from route (1) to route (4) for address decoding, or CAM data input as the first cycle. The sub-block access (read, write, or CAM searching) as the second cycle. And the read data muxing and CAM hit-result priority encoding from route (4) to route (1) as the third cycle. So the SRAM read, SRAM write and CAM search functions can be achieved with three cycle pipe line operation. If high clock rate are required, we can further divide it into more cycles. Say: address decoding, or CAM data input divided into two cycles. Route (1) and route (2) as first cycle. Route (3) and route (4) as second cycle. Block access can also be further divided into two cycles. Read data out and CAM search result address out and priority encoding can be further divided into two cycles. Route (4) and route (3) as one cycle, route (2) and route (1) as another cycle. Total operation will be six cycles.

### Scalable Design

The design described from section [6] to [10], is a scalable design. First, the word number of each sub-block can be changed and will not affect the logic and bus design among each sub-blocks. Second, Without change each sub-block, we can use each sub-block as a basic unit to build one quadruple, or two quadruples, or even partial the column. If we want to have a larger design, we can re-arrange the floor plan and logic partition among each sub-block and increase the block number. In this way, in Silicon process, a few masks can be saved and cost will be reduced. In the design, the sub-block and bus logic can be re-used for different products, man power can be saved.

### In summary

The design described above are for SRAM based content addressable memory (CAM). It is also applied for ternary CAM(TCAM), or DRAM or psudo-SRAM based CAM. All the inventions or points described from section [4] to [12] will be claimed in the following section.

What is claimed is:

1. The LARGE CAM or TCAM are divided into 2^{N} same size small sub-block and each small sub-block has its own address decoding and priority encoding function.

2. The small sub-block are placed symmetrically around the center of the CAM unit.

3. The small sub-block are equally placed in the each quadruples.

4. In each quadruples, The sub-block are placed as a matrix, like 8 column and 8 row.

5. The bus of address and Data to write or match are routed to the mid-point at each Side and then sent to the center of the chip or CAM unit.

6. The writing data are sent to the right side or left side based on the first level decoding, then sent to the particular column based on the second level decoding, then are sent to the particular sub-block based on the third level decoding.

7. only the reading out data take the data bus at different level, say, only the particular sub-block in each column will take the bus and among 8 column, only the column in which there is a reading sub-block will take the data bus.

8. On search or match case, only the highest priority hit sub-block will take the Match Address result bus on that column among the 8 sub-block, then only the highest priority hit column Will take the Match Address result bus among the 8 column.

9. The data writing can be pipe lined into multi-cycle.

10. The address decoding of data writing can be divided into multi-cycle.

11. For Reading data, the address decoding can be divided into multi-cycle.

12. The data read out can be divided into multi-cycle.

13. the address match or search can be divided into multi-cycle.

14. the priority encoding can be divided into multi-cycle.

15. The each sub-block are independent sub-block with its own address decoding and write and read buffer as well as priority encoding.

16. Each sub-block are identical on the internal design and interface.

17. the logic interface in each column among each sub-block are identical.

18. the logic interface among each column for four quadruple are identical.
